(19) United States
(12) Patent Application Publication
(10) Pub. No.: US 2026/0175525 A1
(43) Pub. Date: Jun. 25, 2026

(54) GEODESIC DRAPING METHOD

(71) Applicants: SAFRAN CERAMICS, LE HAILLAN (FR); SAFRAN NACELLES, GONFREVILLE L'ORCHER (FR)

(72) Inventors: Aline PLANCKEEL, MOISSY-CRAMAYEL (FR); Bertrand Léon Marie DESJOYEAUX, MOISSY-CRAMAYEL (FR); Gautier MECUSON, MOISSY-CRAMAYEL (FR); Emilie LESIZZA, MOISSY-CRAMAYEL (FR); Davi SILVA DE VASCONCELLOS, MOISSY-CRAMAYEL (FR)

(21) Appl. No.: 19/126,499

(22) PCT Filed: Oct. 30, 2023
(86) PCT No.: PCT/FR2023/051711

§ 371 Date: May 1, 2025

(30) Foreign Application Priority Data
Nov. 2, 2022 (FR) FR2211382

(51) Int. Cl. B29C 70/20; B29C 70/38

(52) U.S. Cl. CPC B29C 70/207; B29C 70/386

(57) ABSTRACT

A method for draping fibrous structures on a draping shape including at least one developable portion, the fibrous structures including fibers extending in a determined direction, wherein the fibrous structures are deposited on the draping shape so that the fibers of the fibrous structures overlap at straight lines of the developed surface of the developable portion of the draping shape.

### TECHNICAL FIELD

The invention relates to the general field of methods for draping a shape using fibrous structures, and in particular to methods for draping by automatic placement of fibers.

### PRIOR ART

It is known to produce composite parts by draping them on a shape of strata or layers of dry or pre-impregnated fibrous structures. In some current techniques, draping is carried out manually by an operator. These techniques can lead to relatively high part production costs and risks of positioning errors in the layers or fibrous structures. This leads to a certain variability in the mechanical performance of the parts obtained, or even to parts with insufficient mechanical properties.

Mechanized solutions have thus been developed to reduce the production cost of these composite material parts, such as the automatic fiber placement technique, also known as AFP for “Automated Fiber Placement”. Such a technique is in particular described in document FR 3 066 719. The fibers are then automatically deposited in the form of fibrous strips called “strands”.

In the prior art, when it is desired to drape a developable conical or frustoconical draping shape F₀ comprising generatrices g₀₁, g₀₂ and extending between a smaller contour p₀₁ and a larger contour p₀₂, the deposited strands m₀ are oriented according to the Cartesian coordinate system of the draping shape F₀, as illustrated in FIG. 1. Thus, the trajectories of the deposited fibers or fiber strands intersect the generatrices g₀₁, g₀₂ of the developable shape F₀ with the same angle. FIG. 2 shows the developed surface F_{0d} of the developable shape F₀ open at the generatrix g₀₁. It is thus possible to deposit several fibrous layers, each fibrous layer having a different fiber orientation. It is thus possible to achieve quasi-isotropic draping.

However, it has been found that the strands deposited using this method can have significant deformations and undulations. The strength and mechanical characteristics of the draped part obtained using this method may therefore be insufficient.

It is also known to deposit the strands with a “spiral” winding, as described in document U.S. Pat. No. 8,677,622. However, this draping method generates large variations in thickness, with some areas of the draping shape being covered by a lot of fibers and other areas by very few fibers. Furthermore, the part thus draped has a large heterogeneity in the fiber orientations, with not all areas having the same proportion of fibers for each orientation. It is therefore extremely difficult to achieve quasi-isotropic draping with this method.

### DISCLOSURE OF THE INVENTION

The present invention aims at overcoming the aforementioned disadvantages. In particular, it has been found that the further the conical or frustoconical cone-shaped draping shape is from the shape of a cylinder, that is to say, the more the latter has a significant slope relative to its axis, the more difficult it is to apply the strands without undulations or deformations. Indeed, when the strand is deposited on a significant slope with the method(s) of the prior art, the two longitudinal edges of the strand do not travel the same distance on the draping shape. Thus, the deposited strand undulates or deforms. This phenomenon is even more marked when the section of the draping shape is reduced or when the width of the applied strand is large.

Thus, the invention provides a method for draping fibrous structures on a developable draping shape, the fibrous structures comprising fibers extending in at least one determined direction, the method being characterized in that the fibrous structures are deposited on the draping shape so that the fibers of said fibrous structures overlap at straight lines of the developed surface of the draping shape.

Preferably, the developable draping shape comprises at least one portion of conical or frustoconical shape. Indeed, the method as described above is particularly suitable for conical or frustoconical shapes.

According to one variant, the draping shape is not fully developable, and comprises a developable portion. The method of the invention and its variants then apply only to the developable portion of the draping shape.

By depositing the fibers of the fibrous structures so as to follow trajectories corresponding to straight lines of the developed shape of the draping shape, it is ensured that the draping of the fibrous structures is carried out properly, without undulation or deformation.

According to a particular embodiment of the invention, the fibrous structures are draped so as to form one or more developable fibrous layers on the draping shape, the fibrous layer(s) extending around the draping shape between a first and a second edge, the fibrous structures of the same fibrous layer being deposited so that the fibers of the fibrous structures of said fibrous layers overlapping at least at one set of parallel straight lines of the developed surface of said fibrous layer.

Thus, the invention allows to achieve a draping with several layers that are themselves developable. This ensures that multi-layer draping is achieved without any risk of undulation or deformation, despite the superposition of the layers.

According to another particular embodiment of the invention, a set of fibrous layers is draped over the draping shape such that in each fibrous layer of the set of fibrous layers the fibers extend in at least one direction of extension which forms a non-zero crossing angle with the direction(s) of extension of the fibers of the other layers of the set of fibrous layers.

Thus, the draping obtained will have interesting mechanical characteristics in several directions, and will therefore be more robust.

The draping may comprise several sets of fibrous layers, the sets of fibrous layers being identical or distinct from each other.

Preferably, the set of fibrous layers comprises at least three fibrous layers, in order to obtain satisfactory mechanical resistance in sufficiently varied directions.

According to another particular embodiment of the invention, the crossing angle is comprised between 80% and 120% of a multiple of the ratio of 180° by the total number of layers in the set of fibrous layers. Preferably, the crossing angle is comprised between 90% and 110% of a multiple of the ratio of 180° by the total number of layers in the set of fibrous layers.

Thus, this ensures that the most isotropic draping possible is obtained, adapted to the number of layers in the set. For example, in the case where the set of fibrous layers is made up of four fibrous layers, it is advantageous for each fibrous layer to have fibers with an extension direction offset by approximately 45°, 90° and 135° relative to the directions of extension of the fibers in the other three layers to obtain the most isotropic draping possible.

The crossing angle between the fibers of two distinct fibrous layers may be different depending on the portions of the draping. Thus, according to a particular embodiment of the invention, the crossing angle is comprised between 80% and 120% of a multiple of the ratio of 180° by the total number of layers in the set of fibrous layers at least at one generatrix of the draping shape. According to another embodiment of the invention, the crossing angle is comprised between 80% and 120% of a multiple of the ratio of 180° by the total number of layers in the set of fibrous layers at any point of the draping.

According to another particular embodiment of the invention, the first edges of the fibrous layers of the set of fibrous layers are circumferentially offset relative to each other on the draping shape and the second edges of the fibrous layers of the set of fibrous layers are circumferentially offset relative to each other on the draping shape.

Indeed, the edges of the fibrous layers constitute weaknesses in the draping. It is therefore preferable that the edges of the fibrous layers do not overlap on the draping shape, in order to improve the robustness of the draping and the final part obtained.

According to another particular embodiment of the invention, at least a first portion of the second edge of at least one fibrous layer joins the first edge of said fibrous layer, said first portion of the second edge extending from the largest end contour of said fibrous layer connecting the first edge to the second edge.

By draping the fibrous layer so that its edges meet at least in part from the largest end contour of said fibrous layer, it is possible for at least a portion of the fibrous structures emerging from the first or second edge to be able to block the fibrous structures emerging from the other edge. The hold of the draped layer is thus improved. Furthermore, by producing fibrous layers which make a complete turn of the draping shape, it is easier to obtain a generally uniform thickness over the entire circumference of the draping shape.

According to another particular embodiment of the invention, the first and second edges of at least one fibrous layer meet and correspond to a generatrix of said fibrous layer.

According to another particular embodiment of the invention, the first edge of at least one fibrous layer extends in the same direction as the fibers of the fibrous structures of said layer present on the side of the first edge.

The first edge will then be defined by a single fibrous structure, or at least by a very limited number of successive fibrous structures. The first edge will therefore be able to easily block the fibrous structures emerging from the second edge, for example by slightly overlapping the ends of the fibrous structures forming the second edge.

According to another particular embodiment of the invention, the second edge comprises a second portion distinct from the first portion extending in the same direction as the fibers of the fibrous structures of said layer present on the side of the second edge.

Thus, the ends of the fibrous structures emerging at the first and second edges are limited, thus greatly improving the strength of the draping thus obtained. Furthermore, this particular embodiment allows to limit the number of short draped fibrous structures, which have a greater chance of becoming detached from the rest of the draping while they do not provide any real improvement in the mechanical properties. Short fibrous structures are also more difficult to deposit, in particular with the automatic fiber draping method. Finally, such a covering allows to obtain a “net shape” fiber preform, that is to say one that does not require additional cutting operations to cut the protruding fibers.

According to another particular embodiment of the invention, the first edge covers at least the first portion of the second edge.

The first edge can thus better block the fibrous structures emerging from the second edge, by overlapping at the ends of the fibrous structures forming the second edge.

According to another particular embodiment of the invention, the method further comprises draping a plurality of stiffening fibrous structures over the draping shape, the stiffening fibrous structures being draped such that the fibers of said stiffening fibrous structures overlap at generatrices of the developed surface of the draping shape.

By carrying out a “conventional” draping of the fibers along the generatrices, the rigidity and the hold of the draping obtained are improved.

According to a particular embodiment of the invention, the draping of the fibrous structures is carried out by automatic placement of fibers.

Using automatic fiber placement draping improves method repeatability and quality while limiting manufacturing costs.

The invention also relates to a fibrous preform comprising at least one developable portion, said preform comprising a plurality of fibrous layers formed by fibrous structures, characterized in that the fibers of the fibrous structures of at least one fibrous layer correspond to straight lines of the developed surface of the developable portion of the fibrous preform.

Preferably, the developable portion of the fiber preform comprises at least one portion of conical or frustoconical shape.

### BRIEF DESCRIPTION OF THE DRAWINGS

FIG. 1 is a schematic perspective view of a developable draping shape on which fibrous strands according to the prior art are draped.

FIG. 2 is a schematic representation of the developed surface of the shape of FIG. 1.

FIG. 3 is a schematic perspective view of a developable draping shape.

FIG. 4 is a schematic sectional view of an AFP depositing head.

FIG. 5 is a schematic front perspective view of a first geodesic fibrous layer according to the invention having an orientation of 90°.

FIG. 6 is a schematic rear perspective view of the first geodesic fibrous layer of FIG. 5.

FIG. 7 is a schematic view of the developed surface of the first geodesic fibrous layer of FIGS. 5 and 6.

FIG. 8 is a schematic front perspective view of a second geodesic fibrous layer according to the invention having an orientation of 0°.

FIG. 9 is a schematic front perspective view of the second geodesic fibrous layer of FIG. 8.

FIG. 10 is a schematic view of the developed surface of the second geodesic fibrous layer of FIGS. 8 and 9.

FIG. 11 is a schematic front perspective view of a third geodesic fibrous layer according to the invention having an orientation of 45°.

FIG. 12 is a schematic rear perspective view of the third geodesic fibrous layer of FIG. 11.

FIG. 13 is a schematic view of the developed surface of the third geodesic fibrous layer of FIGS. 11 and 12.

FIG. 14 is a schematic front perspective view of a fourth geodesic fibrous layer according to the invention having an orientation of 135°.

FIG. 15 is a schematic rear perspective view of the fourth geodesic fibrous layer of FIG. 14.

FIG. 16 is a schematic view of the developed surface of the fourth geodesic fibrous layer of FIGS. 14 and 15.

FIG. 17 is a schematic perspective view of a geodesic fibrous layer according to a first variant of the invention.

FIG. 18 is a schematic view of the developed surface of the geodesic fibrous layer of FIG. 17.

FIG. 19 is a schematic perspective view of a geodesic fibrous layer according to a second variant of the invention.

FIG. 20 is a schematic view of the developed surface of the geodesic fibrous layer of FIG. 19.

FIG. 21 is a schematic front perspective view of a first draping comprising the first, second, third and fourth geodesic layers of FIGS. 5 to 16.

FIG. 22 is a schematic rear perspective view of the first draping of FIG. 21.

FIG. 23 is a schematic view of the developed surface of the first draping of FIGS. 21 and 22.

FIG. 24 is a schematic front perspective view of a second draping comprising twice the third layer of FIGS. 11 to 13.

FIG. 25 is a schematic rear perspective view of the second draping of FIG. 24.

FIG. 26 is a schematic view of the developed surface of the second draping of FIGS. 24 and 25.

FIG. 27 is a schematic view of a developed surface of a third draping.

### DESCRIPTION OF THE EMBODIMENTS

The invention allows to produce a fiber preform having the shape of the part to be obtained by draping a plurality of fibrous structures on a draping shape. The fiber preform is intended to form the fiber reinforcement of the part to be obtained.

The draping shape comprises an internal or external draping surface intended to be draped by the fibrous structures. The draping of the draping shape is carried out by applying fibrous structures onto the draping surface of said draping shape. Preferably, the draping is carried out on the external surface of the draping shape, which is more accessible. However, it does not depart from the scope of the invention if the draping is carried out on the internal surface of the draping shape.

The draping surface comprises at least one developable portion. The draping surface may be entirely developable. By extension, the term “developable draping shape” refers to a draping shape whose draping surface is developable. The draping surface may have at least one portion of conical or frustoconical shape. The draping shape may be a conical or frustoconical shape. The draping shape may also have a complex developable shape, comprising portions at least partially of conical or frustoconical shape. For example, the draping shape may have a developable crown formed by a plurality of lobes distributed over a circumference, said lobes having for example a partially frustoconical shape. Such a draping shape may for example allow the draping of a fiber preform intended to form the fiber reinforcement of a turbojet flow mixer, the draping shape itself having overall the shape of a turbojet flow mixer. An example of a turbojet flow mixer is described in document FR 3 061 749.

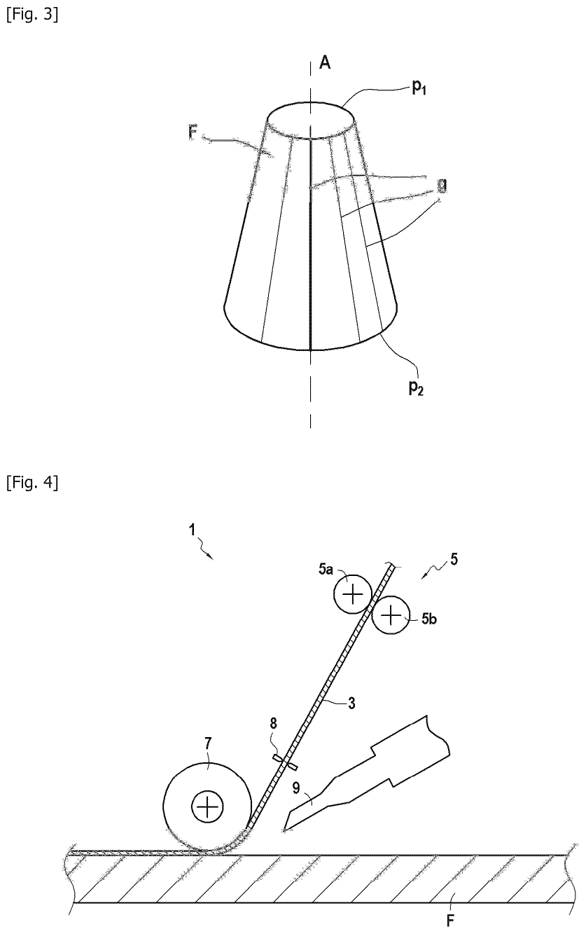

FIG. 3 illustrates an example of a draping shape F. The draping shape F extends around a central axis A. Thus, the draping surface of the draping shape F extends around the central axis A. In the example illustrated in FIG. 3, the draping shape F and the draping surface have a circular section. The central axis A then corresponds to the axis of revolution of the draping surface. However, it does not depart from the scope of the invention if the section of the draping surface is an ellipse, provided that said draping surface remains developable. The central axis then corresponds to the axis passing through the center of all the elliptical sections.

The draping shape F, or the draping surface, extends along the central axis A between a smaller contour p₁ and a larger contour p₂. The smaller contour p₁ corresponds to the end contour of the draping shape F, or the draping surface, of smaller dimension. The larger contour p₂ corresponds to the end contour of the draping shape F, or the draping surface, of larger dimension.

The draping surface of the draping shape F comprises infinitely many generatrices g, as illustrated in FIG. 3.

The fibrous structures are preferably in the form of fibrous strands or fabric plies. A “strand” is understood to mean a set of long fibers or filaments substantially parallel to each other and joined together in a non-woven strip. The fibrous structures may comprise continuous and long fibers. In the case where the fibrous structures are in the form of fabric plies, they are generally formed by the woven interlacing of fibers in two directions, which are usually perpendicular to each other.

The fibers of the fibrous structures may be ceramic, glass, or carbon fibers. The ceramic fibers may be fibers made of a non-oxide material, such as silicon carbide (SiC), or of an oxide material, such as alumina, or of a material comprising predominantly alumina. The glass fibers may comprise a mixture predominantly based on silica.

The fibrous structures may be dry, that is to say not impregnated with a resin, pre-impregnated or filled with particles. The fibers of the dry fibrous structures may, however, be coated with a temporary binder, for example organic, which may or may not be removed before the densification of said fibrous structures.

The fibrous structures may be impregnated with a thermoplastic or thermosetting material, which may include solid fillers. The fibrous structures may also be impregnated with a thermoplastic or thermosetting material that does not comprise solid fillers. The fibrous structures may be impregnated only with an organic phase consisting of a thermoplastic material.

Thermoplastic materials that can impregnate the fibrous structures can be selected from: polyaryletherketones (PAEK) such as polyetheretherketone (PEEK) and polyetherketoneketone (PEKK), polyetherimides (PEI), polyphenylene sulfide (PPS), polyvinyl alcohol (PVA), aliphatic polyethers and polysulfone (PSU). Thermosetting materials that can impregnate the fibrous structures can be selected from: epoxies, phenolics and polybismaleimides (BMI).

Pre-impregnation of the fibrous structures can be carried out by any conventional technique, for example by dipping, by roller application or by spraying. The fibrous structures can be applied onto the shape F by manual draping. Preferably, in order to improve the repeatability and quality of the application of the fibrous structures onto the shape F while reducing the operating time, the fibrous structures are applied onto the shape F by automatic fiber placement.

FIG. 4 schematically illustrates the structure of a deposition head 1 of a device for implementing an automatic fiber placement technique. The structure of the deposition head 1 is well known. The deposition head 1 is fed by the fibrous structures 3, preferably in the form of a strip or a strand.

The strip or strand 3 can be routed by a conveying element 5 to a pressure application element 7 located on the side of the draping shape F. The conveying element 5 is here in the form of a pair of counter-rotating rollers 5a and 5b between which the strip or strand 3 is present. The conveying element 5 allows to advance the strip or strand 3 to the pressure application element 7. The pressure application element 7 applies pressure to the strip or strand 3 in order to carry out the deposition on the draping shape F. The pressure application element 7 is here in the form of a roller.

The deposition head 1 may, in addition, include a heating element 9 located in the vicinity of the pressure application element 7. This heating element 9 allows, in the case of a strip or strand 3 impregnated with a thermoplastic polymer, to heat said impregnated strip or strand 3 during its deposition in order to fluidify the thermoplastic polymer and thus to confer the desired adhesive power to the deposited strip or strand 3.

During deposition, the deposition head 1 is movable in order to apply the strip or strand 3 along a first determined trajectory onto the draping shape F. Once the application has been carried out along this first trajectory, a cutting element 8 of the deposition head 1 cuts the strip or strand 3. After this cutting, the deposition of a first fibrous structure is thus obtained, formed by a first section of the strip or strand 3, along a first trajectory on the draping shape F.

The draping operation is then continued by advancing the strip or strand 3 in the deposition head 1 to the pressure application element 7 by actuating the conveying element 5. The deposition head 1 can be moved in order to deposit the strand or strip 3 along a second trajectory on the draping shape F. The deposition of a second fibrous structure, formed by a second section of the strip or strand 3 along a second trajectory, is then obtained in a manner similar to that described previously.

The draping shape F can obviously be rotated around its central axis A during draping to facilitate the deposition of the fibrous structures.

The draping is then continued by depositing several other fibrous structures in the same manner as described previously.

Regardless of the draping method used, the fibrous structures can be deposited so as to shape fibrous layers on the draping shape F. Thus, each fibrous layer is itself developable, itself extends around the central axis A and itself has an infinite number of generatrices. The fibrous layers extend around the draping shape F between a first edge and a second edge.

The fibrous layers extend along the central axis A between a smaller contour and a larger contour. The smaller contour corresponds to the end contour of the smaller fibrous layer. The larger contour corresponds to the end contour of the larger fibrous layer. The end contours of a fibrous layer correspond to the ends of the fibrous layer opposite each other along the central axis A. The smaller contour and the larger contour connect the first edge and the second edge.

Preferably, at least a first portion of the second edge of the fibrous layers joins the first edge, said first portion of the second edge extending from the largest end contour of the fibrous layer. At least the first portion of the second edge of the fibrous layers and the first edge may thus be merged.

In the present application, it is considered that two edges or portions of edges merged with a fibrous layer are overlapping, immediately adjacent or spaced with a very small clearance in front of the perimeter of the section of said fibrous layer.

In accordance with the invention, the trajectories of the fibrous structures deposited on the draping shape F are determined, that is to say the trajectories of the fibers of the draped fibrous structures are determined. The trajectories of the fibrous structures deposited on the draping shape F preferably correspond to the trajectories of the fibers deposited on the draping shape F.

According to the invention, the fibrous structures of at least one fibrous layer are deposited such that the fibers of said fibrous structures overlap at straight lines of the developed surface of the draping shape F. Thus, said fibrous layer is itself developable, and the fibers present in said fibrous layer extend along trajectories which correspond to straight lines on the developed surface of said layer. Said fibrous layer is therefore geodesic.

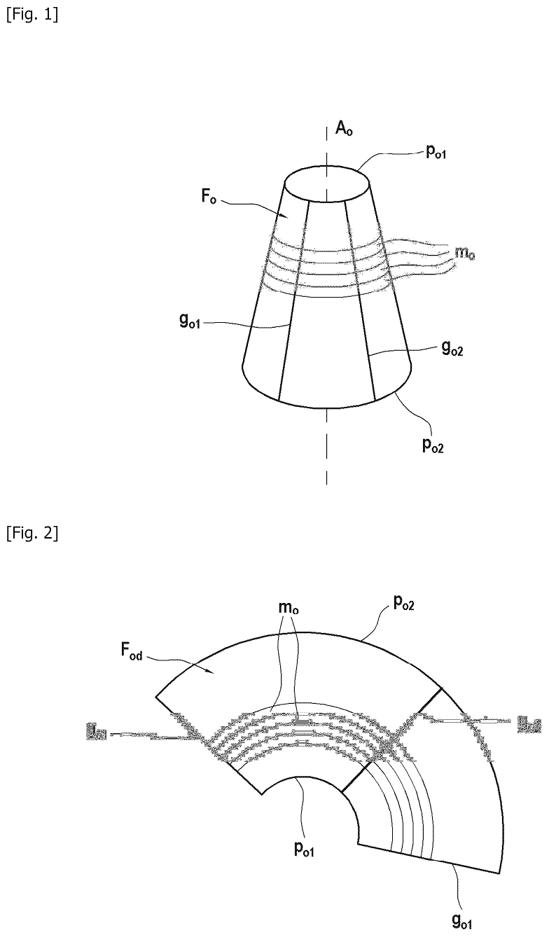

Here, the term “geodesic” refers to a developable fibrous layer in which the fibers of the fibrous structures extend along trajectories that correspond to straight lines of the developed surface of said layer. Said trajectories are also referred to as “geodesic”. In contrast, here, the term “Cartesian” refers to a developable fibrous layer in which the fibers of the fibrous structures extend along trajectories that intersect the generatrices of said fibrous layer with a constant angle, or that coincide with the generatrices of said fibrous layer. These trajectories are also referred to as “Cartesian”. FIGS. 1 and 2 illustrate an example of a Cartesian fibrous layer, in which the strands m₀ extend along Cartesian trajectories.

Preferably, within a geodesic fibrous layer, the fibers of the fibrous structures extend along trajectories which correspond to a set of parallel straight lines of the developed surface of said layer. Here, the term “uniform geodesic” denotes a developable fibrous layer in which the fibers of the fibrous structures extend along trajectories which correspond to a set of parallel straight lines of the developed surface of said layer.

When at least the first portion of the second edge of a uniform geodesic fibrous layer joins the first edge of said fibrous layer, the fibrous layer is defined by a reference generatrix and by an orientation.

The reference generatrix of such a uniform geodesic fibrous layer is the generatrix of the fibrous layer furthest from the generatrix of said fibrous layer extending from the intersection between the smallest contour of the fibrous layer and the extension of the first portion of the second edge. The orientation of such a uniform geodesic fibrous layer is the angle of intersection between the trajectories of the fibers of the fibrous structures of the fibrous layer and the reference generatrix. The orientation of a uniform geodesic fibrous layer corresponds to the orientation of the geodesic trajectories within said layer. If the reference generatrix coincides with a geodesic trajectory of said layer, that is to say coincides with a trajectory of a fibrous structure of said layer, the orientation of the layer is considered to be 0°.

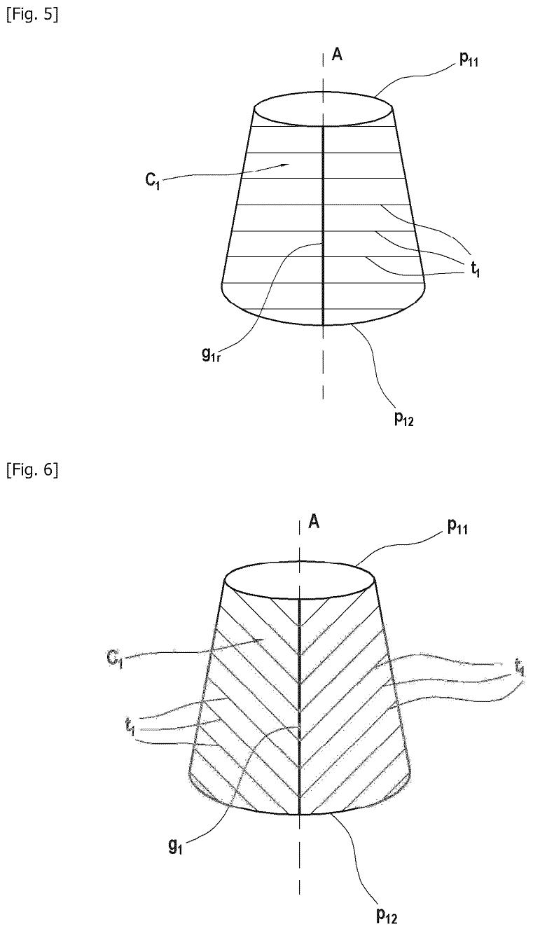

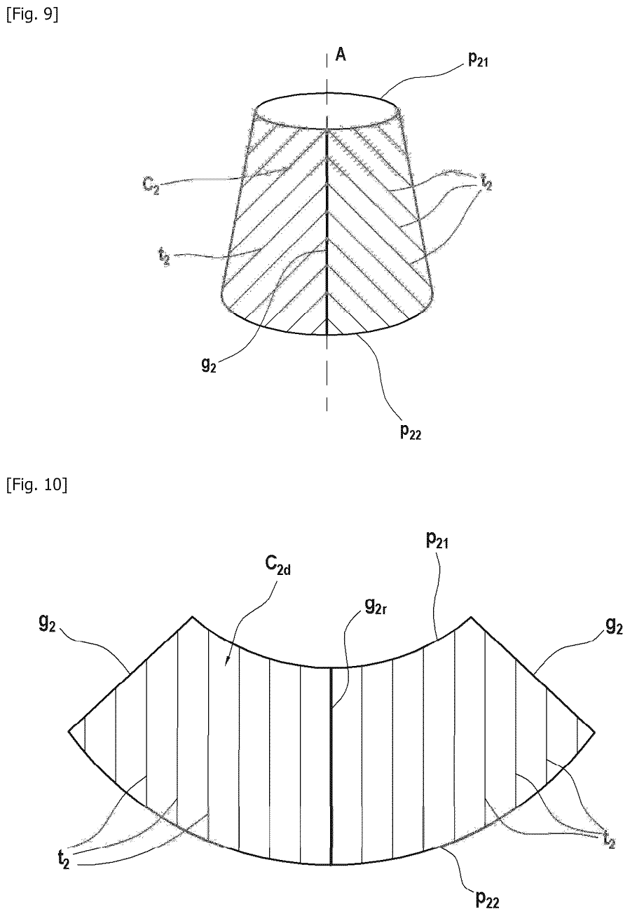

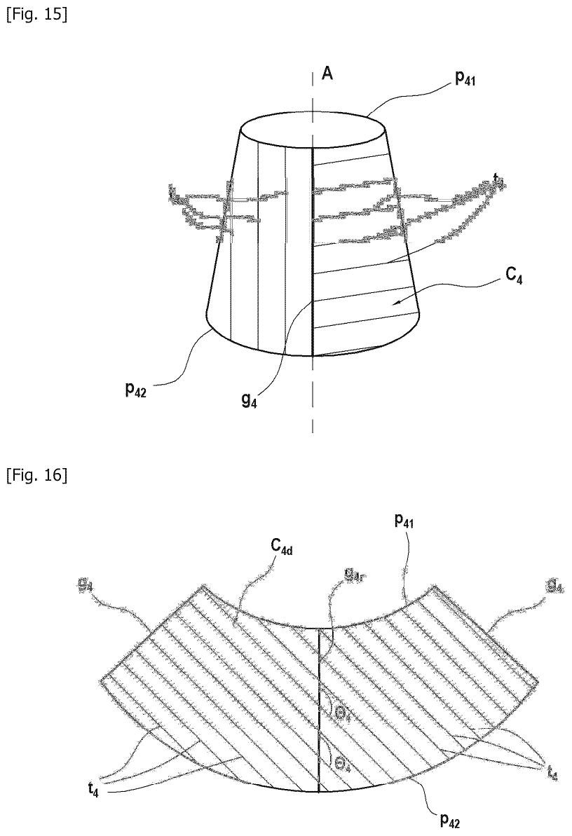

FIGS. 5 to 16 illustrate four examples of uniform geodesic fibrous layers C₁, C₂, C₃, C₄ within which the fibers of the fibrous structures are deposited along geodesic trajectories t₁, t₂, t₃, t₄, the first edge and the second edge of each layer C₁, C₂, C₃, C₄ meeting and corresponding to a singular generatrix g₁, g₂, g₃, g₄ of said fibrous layer C₁, C₂, C₃, C₄.

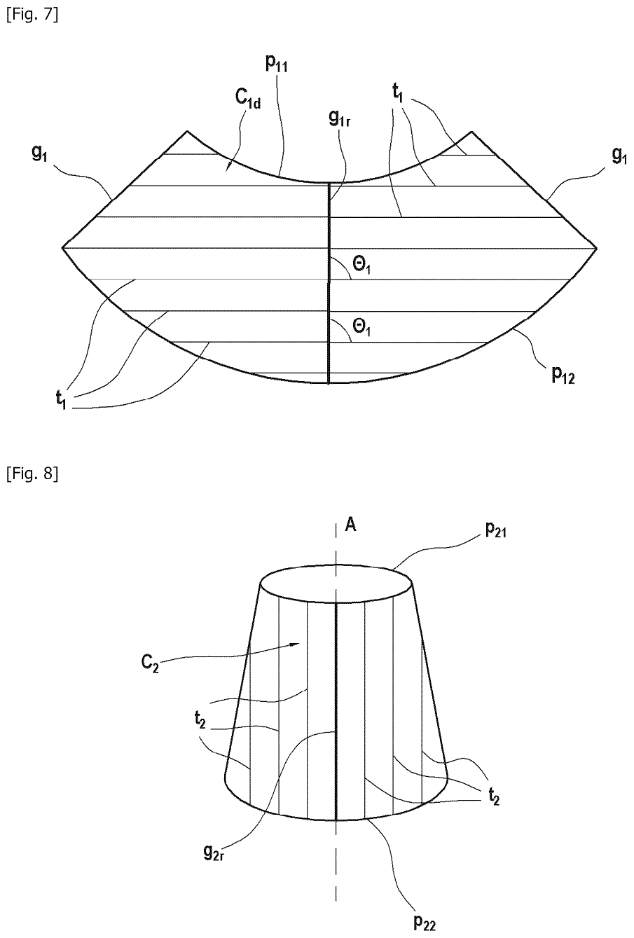

FIGS. 5 to 7 schematically illustrate a first uniform geodesic layer C₁ within which the fibers of the fibrous structures extend according to first geodesic trajectories t₁ which correspond to straight lines on the developed surface Cid of said layer C₁. In particular, the first geodesic trajectories t₁ correspond to a set of parallel straight lines of the developed surface Cid of said layer C₁ as illustrated in FIG. 7.

The first layer C₁ extends around the central axis A between a first edge and a second edge which meet and correspond to a first singular generatrix g₁. The first layer C₁ extends along the central axis A between a smaller end contour p₁₁ and a larger end contour p₁₂.

The fibrous layer C₁ also comprises a first reference generatrix g₁ᵣ which corresponds to the generatrix diametrically opposite the first and second edges, that is to say to the generatrix diametrically opposite the first singular generatrix g₁.

The orientation θ₁ of the geodesic trajectories t₁ within the uniform geodesic fibrous layer C₁ is defined by the angle formed between the first geodesic trajectories t₁ and the first reference generatrix g₁ᵣ. In the example of the first fibrous layer C₁, the first geodesic trajectories t₁ intersect the first reference generatrix g₁ᵣ with an angle of 90°. The first uniform geodesic layer C₁ therefore has an orientation θ₁ of 90°.

FIGS. 8 to 10 schematically illustrate a second uniform geodesic layer C₂ within which the fibers of the fibrous structures extend according to second geodesic trajectories t₂ which correspond to straight lines on the developed surface C_{2d} of said layer C₂. In particular, the second geodesic trajectories t₂ correspond to a set of parallel straight lines of the developed surface C_{2d} of said layer C₂, as illustrated in FIG. 10.

The second layer C₂ extends around the central axis A between a first edge and a second edge which meet and correspond to a second singular generatrix g₂. The second layer C₂ extends along the central axis A between a smaller end contour p₂₁ and a larger end contour p₂₂.

The fibrous layer C₂ also comprises a second reference generatrix g₂ᵣ which corresponds to the generatrix diametrically opposite the first and second edges, that is to say to the generatrix diametrically opposite the second singular generatrix g₂.

The orientation θ₂ of the geodesic trajectories t₂ within the uniform geodesic fibrous layer C₂ is defined by the angle formed between the geodesic trajectories t₂ and the second reference generatrix g₂ᵣ. In the example of the second fibrous layer C₂, the second geodesic trajectories t₂ do not intersect the second reference generatrix g₂ᵣ, except for a second geodesic trajectory t₂ which is coincident with the second reference generatrix g₂ᵣ. The second uniform geodesic layer C₂ therefore has an orientation θ₂ of 0°.

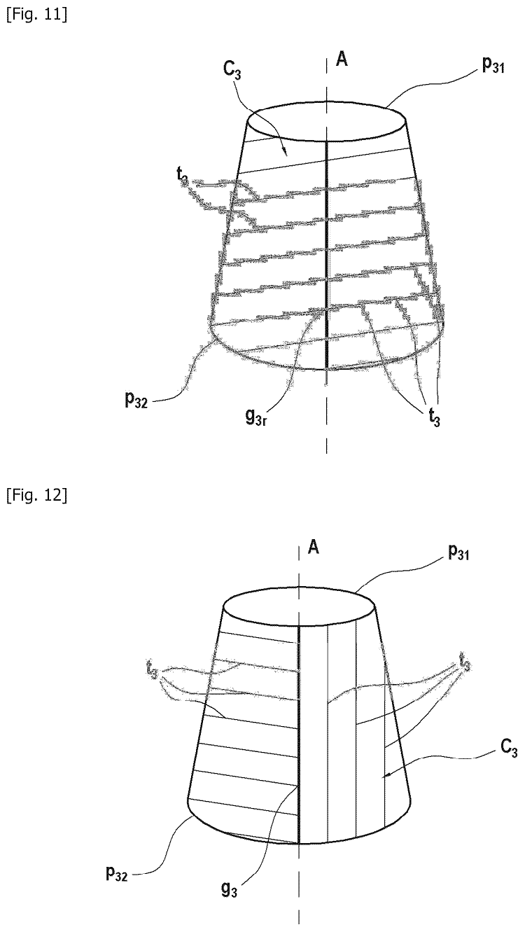

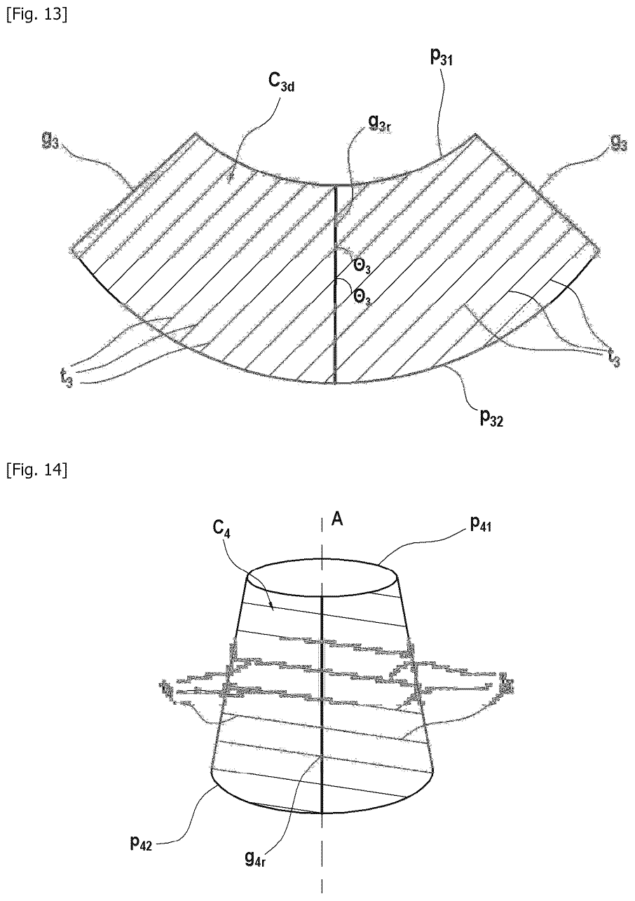

FIGS. 11 to 13 schematically illustrate a third uniform geodesic layer C₃ within which the fibers of the fibrous structures extend according to third geodesic trajectories t₃ which correspond to straight lines on the developed surface C_{3d} of said layer C₃. In particular, the third geodesic trajectories t₃ correspond to a set of parallel straight lines of the developed surface C_{3d} of said layer C₃, as illustrated in FIG. 13.

The third layer C₃ extends around the central axis A between a first edge and a second edge which meet and correspond to a third singular generatrix g₃. The third layer C₃ extends along the central axis A between a smaller end contour p₃₁ and a larger end contour p₃₂.

The fibrous layer C₃ also comprises a third reference generatrix g₃ᵣ which corresponds to the generatrix diametrically opposite the first and second edges, that is to say to the generatrix diametrically opposite the third singular generatrix g₃.

The orientation θ₃ of the geodesic trajectories t₃ within the uniform geodesic fibrous layer C₃ is defined by the angle formed between the geodesic trajectories t₃ and the reference generatrix g₃ᵣ. In the example of the third fibrous layer C₃, the third geodesic trajectories t₃ intersect the third reference generatrix g₃ᵣ with an angle of 45°. The third uniform geodesic layer C₃ therefore has an orientation θ₃ of 45°.

FIGS. 14 to 16 schematically illustrate a fourth uniform geodesic layer C₄ within which the fibers of the fibrous structures extend according to fourth geodesic trajectories t₄ which correspond to straight lines on the developed surface C_{4d} of said layer C₄. In particular, the fourth geodesic trajectories t₄ correspond to a set of parallel straight lines of the developed surface C_{4d} of said layer C₄, as illustrated in FIG. 16.

The fourth layer C₄ extends around the central axis A between a first edge and a second edge which meet and correspond to a fourth singular generatrix g₄. The fourth layer C₄ extends along the central axis A between a smaller end contour p₄₁ and a larger end contour p₄₂.

The fibrous layer C₄ also comprises a fourth reference generatrix gar which corresponds to the generatrix diametrically opposite the first and second edges, that is to say to the generatrix diametrically opposite the fourth singular generatrix g₄. The orientation θ₄ of the geodesic trajectories t₄ within the uniform geodesic fibrous layer C₄ is defined by the angle formed between the geodesic trajectories t₄ and the reference generatrix g₄ᵣ. In the example of the fourth fibrous layer C₄, the fourth geodesic trajectories t₄ intersect the fourth reference generatrix gar with an angle of 135°. The fourth uniform geodesic layer C₄ therefore has an orientation θ₄ of 135°.

According to a first variant, one or more geodesic uniform layers may have a first edge and a second edge joining together, the first edge extending in the same direction as the geodesic trajectories present on the side of said first edge. This variant is particularly advantageous in the case where none of the fibers of the fibrous structures of said layer extends along a generatrix of said layer. Indeed, if in such a case it is chosen to produce edges extending along a generatrix as is the case in FIGS. 6 to 10, there is a risk that the ends of the fibrous structures are not sufficiently blocked at the first and second edges, because the first and second edges are each formed by a plurality of ends of fibrous structures. By choosing a first edge extending along the trajectory of the fibrous structures present on the side of said first edge, said first edge is then formed by the edge of a single fibrous structure, or at least by the edge of a very limited number of fibrous structures. Thus, the first edge can more easily block the ends of the fibrous structures opening at the second edge, for example by covering, over a small distance, the ends of the fibrous structures opening at the second edge.

“Side of the first edge” means the side of the fibrous layer extending from the first edge and away from the second edge. Thus, the side of the first edge does not comprise the second edge. Similarly, “side of the second edge” means the side of the fibrous layer extending from the second edge and away from the first edge. Thus, the side of the second edge does not comprise the first edge.

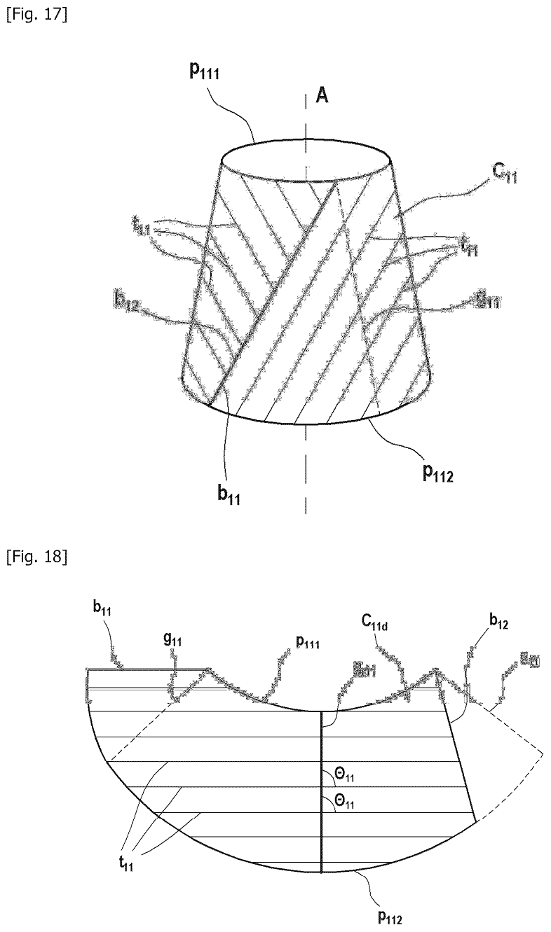

FIGS. 17 and 18 illustrate an example of the first variant of uniform geodesic fibrous layer C₁₁ within which the fibers of the fibrous structures are deposited along geodesic trajectories t₁₁, the first edge bin and the second edge b₁₂ of the layer C₁₁ meet and the first edge b₁₁ extending along the same direction as the geodesic trajectories t₁₁ present on the side of the first edge b₁₁.

The geodesic trajectories t₁₁ correspond to straight lines on the developed surface C_{11d} of said layer C₁₁. In particular, the geodesic trajectories t₁₁ correspond to a set of parallel straight lines of the developed surface C_{11d} of said layer C₁₁ as illustrated in FIG. 18.

The layer C₁₁ according to this first variant extends around the central axis A between the first edge b₁₁ and the second edge b₁₂ which meet, and do not correspond to a generatrix of said layer C₁₁. The first edge b₁₁ extends entirely in the same direction as the geodesic trajectories t₁₁ present on the side of the first edge b₁₁. The layer C₁₁ extends along the central axis A between a smaller end contour p₁₁₁ and a larger end contour p₁₁₂.

The fibrous layer C₁₁ also comprises a reference generatrix gᵣ₁₁, which is the generatrix of the fibrous layer C₁₁ furthest from the generatrix g₁₁ of said fibrous layer C₁₁ extending from the intersection between the smallest contour p₁₁₁ of the fibrous layer C₁₁ and the extension of the second edge b₁₂.

The orientation θ₁₁ of the geodesic trajectories t₁₁ within the uniform geodesic fibrous layer C₁₁ is defined by the angle formed between the geodesic trajectories t₁₁ and the reference generatrix gᵣ₁₁. In the example of the fibrous layer C₁₁, the geodesic trajectories t₁₁ intersect the reference generatrix gᵣ₁₁ with an angle of 90°. The uniform geodesic layer C₁₁ therefore has an orientation θ₁₁ of 90°. The uniform geodesic layer C₁₁ illustrated in FIGS. 17 and 18 therefore has the same orientation as the first uniform geodesic layer C₁ illustrated in FIGS. 5 to 7.

According to a second variant, one or more geodesic uniform layers may have a first edge and a first portion of a second edge meeting and extending in the same direction as the trajectories of the fibers of the fibrous structures of the layer present on the side of the first edge, the first portion of the second edge extending from the largest contour of the fibrous layer and a second portion of the second edge extending in the same direction as the trajectories of the fibrous structures of the layer present on the side of said second edge.

This variant is particularly advantageous in the case where none of the fibers of the fibrous structures of said layer extends along a generatrix of said layer. Indeed, if in such a case it is chosen to produce edges extending along a generatrix as is the case in FIGS. 6 to 10, there is a risk that the ends of the fibrous structures are not sufficiently blocked at the first and second edges, because the first and second edges are each formed by a plurality of ends of fibrous structures. By choosing a first edge extending along the trajectory of the fibrous structures present on the side of said first edge, said first edge is then formed by the edge of a single fibrous structure, or at least by the edge of a very limited number of fibrous structures. Thus, the first edge can more easily block the ends of the fibrous structures opening at the second edge, for example by covering, over a small distance, the ends of the fibrous structures opening at the second edge.

Furthermore, by producing a second portion of the second edge extending along the geodesic trajectories of the fibers of the fibrous structures present on the side of the second edge, the number of short fibers or fibrous structures is reduced by creating in return an area not covered by the layer between the second portion of the second edge and the first edge. The draping of the fibrous layer is thus improved, since it is difficult to drape short fibrous structures. Furthermore, in this second variant, it is avoided that fibrous structures open onto the smallest contour in the form of visible free ends, which would require additional cutting operations.

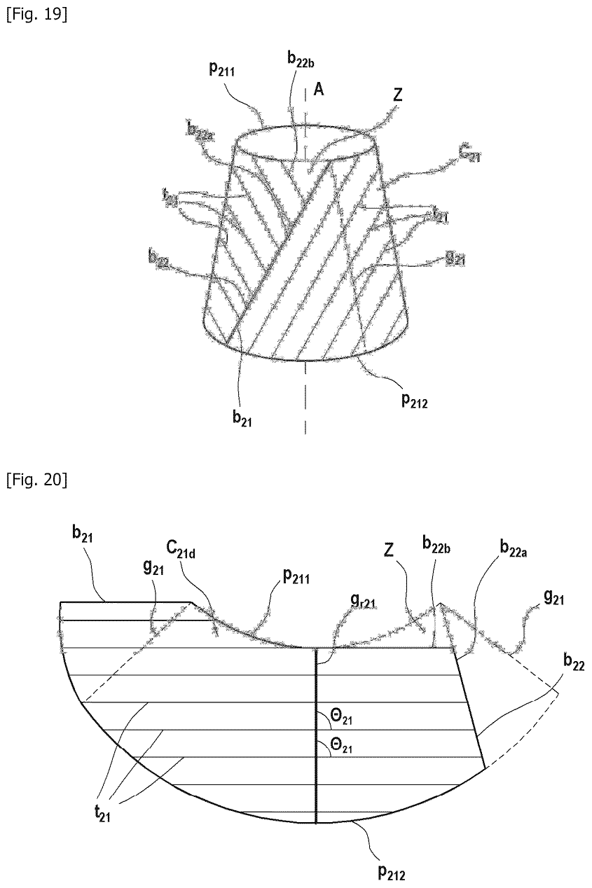

FIGS. 19 and 20 illustrate an example of the second variant of uniform geodesic fibrous layer C₂₁ within which the fibers of the fibrous structures are deposited along geodesic trajectories t₂₁. The layer C₂₁ according to this second variant extends around the central axis A between a first edge b₂₁ and a second edge b₂₂. In this variant, the second edge b₂₂ of the layer C₂₁ comprises a first portion b₂₂ₐ merged with the first edge b₂₁ of said layer C₂₁ and extending along the same direction as the trajectories t₂₁ of the fibers of the fibrous structures of the layer C₂₁ present on the side of the first edge b₂₁. The second edge b₂₂ of the layer C₂₁ further comprises a second portion b_{22b} extending in the same direction as the trajectories t₂₁ of the fibers of the fibrous structures of the layer C₂₁ present on the side of said second edge b₂₂.

The geodesic trajectories t₂₁ correspond to straight lines on the developed surface C_{21d} of said layer C₂₁. In particular, the geodesic trajectories t₂₁ correspond to a set of parallel straight lines of the developed surface C_{21d} of said layer C₂₁ as illustrated in FIG. 20.

The layer C₂₁ extends along the central axis A between a smaller end contour p₂₁₁ and a larger end contour p₂₁₂.

The fibrous layer C₂₁ also comprises a reference generatrix gᵣ₂₁, which is the generatrix of the fibrous layer C₂₁ furthest from the generatrix g₂₁ of said fibrous layer C₂₁ extending from the intersection between the smallest contour p₂₁₁ of the fibrous layer C₁₁ and the extension of the first portion b₂₂ₐ second edge b₂₂.

The orientation θ₂₁ of the geodesic trajectories t₂₁ within the uniform geodesic fibrous layer C₂₁ is defined by the angle formed between the geodesic trajectories t₂₁ and the reference generatrix gᵣ₂₁. In the example of the fibrous layer C₂₁, the geodesic trajectories t₂₁ intersect the reference generatrix gᵣ₂₁ with an angle of 90°. The uniform geodesic layer C₂₁ therefore has an orientation θ₂₁ of 90°. The uniform geodesic layer C₂₁ illustrated in FIGS. 19 and 20 therefore has the same orientation as the first uniform geodesic layer C₁ illustrated in FIGS. 5 to 7 and the uniform geodesic layer C₁₁ illustrated in FIGS. 17 and 18.

The draping of the shape F may comprise the production of several uniform geodesic fibrous layers on the draping shape F. The orientation of each uniform geodesic fibrous layer applied is chosen according to the mechanical characteristics desired for the part to be obtained. When it is desired to obtain a quasi-isotropic draping, stacks of uniform geodesic fibrous layers are produced allowing a quasi-isotropic distribution of the fibers at any point of the draped fiber preform.

According to a first embodiment of the invention, the draping of the shape F comprises the production of several uniform geodesic fibrous layers on the draping shape F, the first and second edges of the fibrous layers overlapping on the draping shape F. In this first embodiment, the reference generatrices of said fibrous layers are overlapping on the shape F.

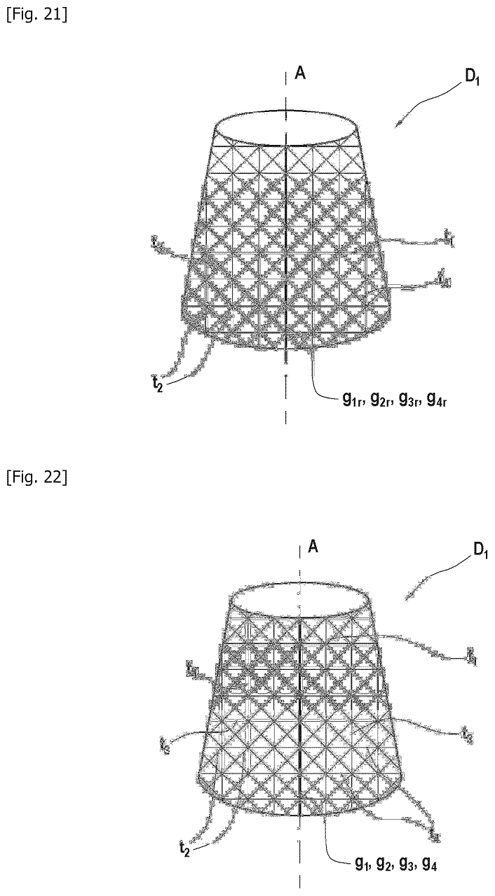

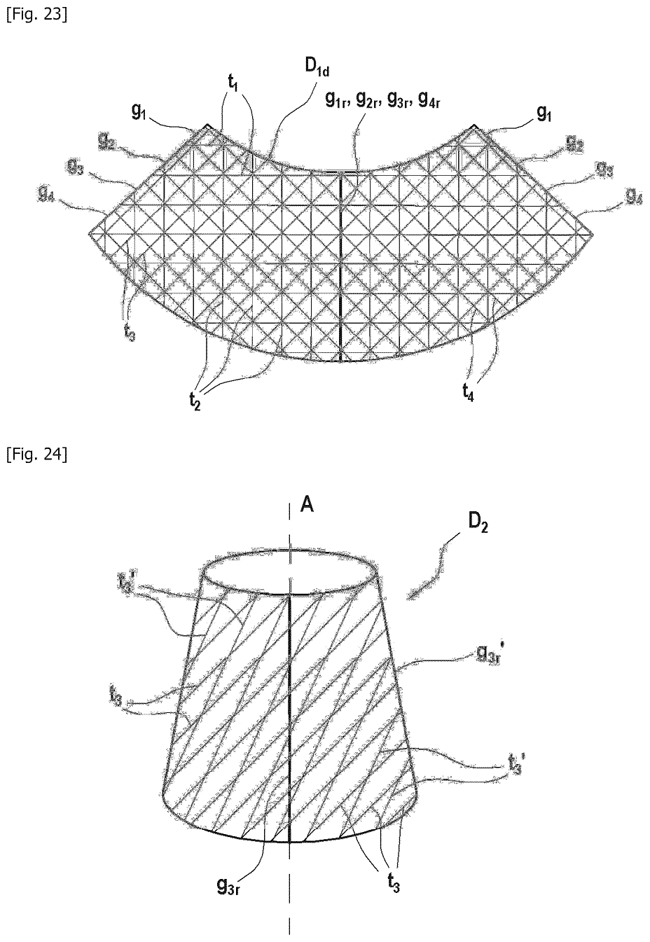

An example of draping D₁ and of development D_{1d} according to this first embodiment of the invention is shown in FIGS. 21 to 23, in which a set of fibrous layers consisting of the first, second, third and fourth uniform geodesic fibrous layers C₁, C₂, C₃ and C₄ illustrated in FIGS. 5 to 16 has been applied to the draping shape F so that the reference generatrices g₁ᵣ, g₂ᵣ, g₃ᵣ and gar are overlapping on the shape F. By thus overlapping uniform geodesic fibrous layers having orientations θ₁, θ₂, θ₃ and θ₄ of 90°, 0°, 45° and 135°, a quasi-isotropic draping is thus obtained at any point of the draped fiber preform.

Thus, in each fibrous layer C₁, C₂, C₃, C₄ of the set of fibrous layers presented, the fibers extend in a direction of extension t₁, t₂, t₃, t₄, also called trajectory, which forms a non-zero crossing angle with the directions of extension or trajectories t₁, t₂, t₃, t₄ of the fibers of the other layers C₁, C₂, C₃, C₄.

In the example shown in FIGS. 21 to 23, the set of fibrous layers comprises four layers, and the crossing angle between the different layers of the set is a multiple of 45°, which corresponds to a multiple of the ratio of 180° by 4. The set of fibrous layers illustrated therefore allows a quasi-isotropic distribution of the fibers of the draping. This crossing angle is identical at every point of the draping D₁ shown in FIGS. 21 to 23, that is to say identical at all the generatrices of the draping shape F.

Obviously, several sets of uniform geodesic fibrous layers are possible to obtain quasi-isotropic draping at any point of the draped fibrous preform according to this first embodiment of the invention. For example, uniform geodesic fibrous layers having orientations of:
−0°+α, 60°+α, and 120°+α, where α is comprised between 0° and 60°; or
0°+α, 45°+α, 90°+α and 135°+α, where α is comprised between 0° and 45°; or
0°+α, 36°+α, 72°+α, 108°+α and 144°+α, where α is comprised between 0° and 36°; or
0°+α, 30°+α, 60°+α, 90°+α, 120°+α and 150°+α, where α is comprised between 0° and 30°.

The above combinations can obviously be repeated several times in the thickness of the draped preform, that is to say a set of fibrous layers can be repeated several times.

In the example illustrated in FIGS. 21 to 23, the edges of the draped fibrous layers coincide with generatrices. It is of course not outside the scope of the invention if all or part of the draped fibrous layers are fibrous layers according to the first variant and/or the second variant described above, their reference generatrices overlapping on the draping shape.

According to a second embodiment of the invention, the draping of the shape F comprises the production of several uniform geodesic fibrous layers on the draping shape F, the first and second edges of the draped fibrous layers being offset relative to each other circumferentially on the draping shape F. Thus, in this second embodiment of the invention, the reference generatrices of all or part of said fibrous layers are offset relative to each other on the shape F.

In this second embodiment of the invention, the draping of the shape F can thus comprise identical uniform geodesic fibrous layers, or at least of the same orientation, but the first and second edges of which are offset relative to each other on the shape F. The angular offset between the first and second edges of each of the uniform geodesic fibrous layers can be determined so as to obtain a quasi-isotropic draping at any point of the fiber preform. This amounts to determining the angular offset between the reference generatrices of each of the uniform geodesic fibrous layers so as to obtain a quasi-isotropic draping at any point of the fiber preform.

An example of draping D₂ and of development D_{2d} according to this second embodiment of the invention is shown in FIGS. 24 to 26, in which two third uniform geodesic fibrous layers C₃ such as the third geodesic fibrous layer illustrated in FIGS. 11 to 13 have been applied to the draping shape F so that the reference generatrices g₃ᵣ and g₃ᵣ′ of these two third layers are offset relative to each other on the shape F. Consequently, the reference generatrices g₃ᵣ and g₃ᵣ′ of these two identical fibrous layers C₃ are superimposed on distinct generatrices of the draping shape F.

The first and second edges of one of the fibrous layers are merged with a generatrix g₃ and the first and second edges of the other fibrous layer are merged with a generatrix g₃′. The orientations θ₃ of the two third uniform geodesic fibrous layers C₃ are identical. The trajectories t₃ of one of the fibrous layers and the trajectories t₃′ of the other fibrous layer are not merged, and intersect.

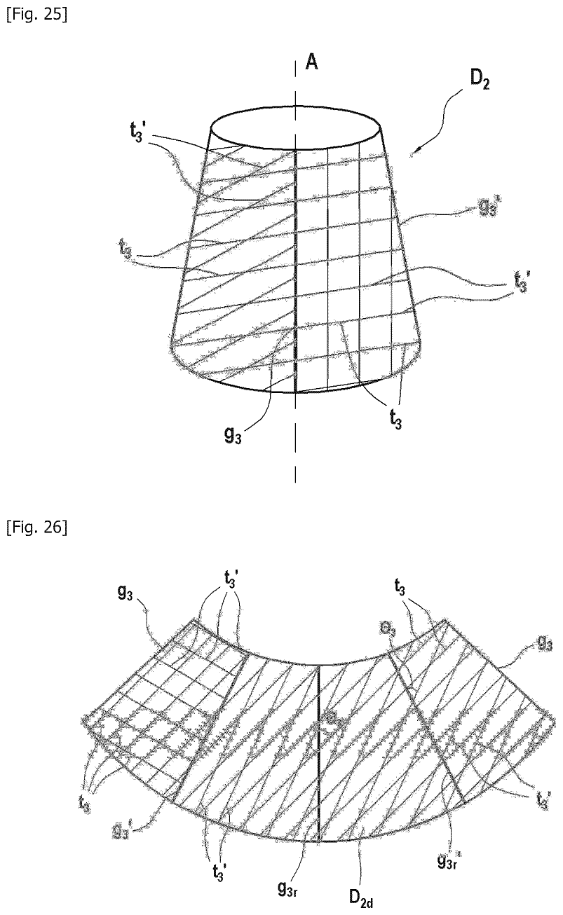

It can be seen in FIGS. 25 and 26 that the crossing angle between the directions of extension of the fibers of the two layers C₃ is different depending on the areas of the draping D₂. In the largest portion of the draping D₂ extending between the generatrices g₃ and g₃′ the crossing angle between the directions of extension t₃ and t₃′ of the two fibrous layers will be approximately 30°, whereas in the smallest portion of the draping D₂ extending between the generatrices g₃ and g₃′ the crossing angle between the directions of extension t₃ and t₃′ of the two fibrous layers will be approximately 60°.

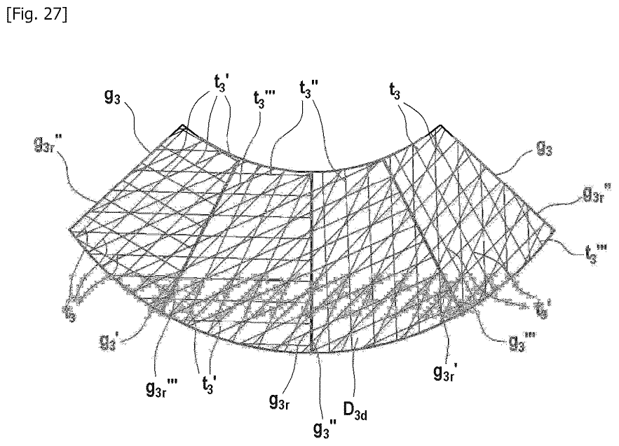

FIG. 27 illustrates an example of draping and development D_{3d} according to this second embodiment of the invention, which comprises a set of fibrous layers comprising four third uniform geodesic fibrous layers C₃ such that the third geodesic fibrous layer illustrated in FIGS. 11 to 13 and 24 to 26 have been applied to the draping shape F so that the reference generatrices g₃ᵣ, g₃ᵣ′, g₃ᵣ″ and g₃ᵣ″ of these four third layers are offset relative to each other on the shape F. Consequently, the reference generatrices g₃ᵣ, g₃ᵣ′, g₃ᵣ″ and g₃ᵣ″ of these four identical fibrous layers C₃ are overlapping at distinct generatrices of the draping shape F. Thus, varied fiber extension directions are obtained in the entire draping, which approaches an isotropic configuration.

The first and second edges of each fibrous layer C₃ are coincident with a generatrix g₃, g₃′, g₃″ or g₃″. The orientations θ₃ of the four third uniform geodesic fibrous layers C₃ are identical.

It can be seen in FIG. 27 that the crossing angle between the directions of extension of the fibers of the different layers is different depending on the areas of the draping, said areas being delimited by the generatrices g₃, g₃′, g₃″ or g₃″.

In the example illustrated in FIGS. 24 to 26 and in FIG. 27, the edges of the draped fibrous layers coincide with generatrices. It is of course not outside the scope of the invention if all or part of the draped fibrous layers are fibrous layers according to the first variant and/or the second variant described above, their reference generatrices being offset around the draping shape.

It is also possible to combine the first embodiment and the second embodiment of the invention. For example, it is possible to achieve quasi-isotropic draping by using a first pair of identical layers and a second pair of identical layers different from the first pair of layers, the reference generatrices of the layers overlapping at distinct generatrices of the draping shape.

In all the embodiments presented above, the fibrous layers draped over the shape F may be only geodesic fibrous layers. The fibrous layers draped over the shape F may be only uniform geodesic fibrous layers. The draping of the shape F may also be a combination of geodesic fibrous layers and Cartesian fibrous layers. It is particularly advantageous to combine uniform geodesic fibrous layers having different orientations, as presented above, with one or more Cartesian fibrous layers in which the fibrous structures are deposited so that the fibers of said fibrous structures are superimposed on the generatrices g of the draping shape F. This significantly increases the rigidity and strength of the fiber preform obtained by draping.

The draping method may comprise draping over the draping shape F, but may also comprise draping over an additional draping shape extending the draping shape F. This additional draping shape is not necessarily developable. The draping performed over this additional draping shape may be different from that described in the present invention.

The fibrous layers draped over the draping shape form a fibrous preform, which has at least one developable portion comprising at least one portion of conical or frustoconical shape. According to the invention, the fibers of the fibrous structures of at least one fibrous layer of the fibrous preform extend along trajectories which correspond to straight lines of the developed surface of the fibrous preform. Preferably, the fibers of the fibrous structures of at least one other fibrous layer of the fibrous preform extend along trajectories which are superimposed on generatrices of the fibrous preform.

The fibrous preform thus obtained can be densified in a well-known manner by a matrix to obtain a part made of composite material, for example an engine exhaust cone or a rear inverter body.

1. A method for draping fibrous structures on a draping shape comprising at least one developable portion, the developable portion comprising at least one portion of conical or frustoconical shape or comprising portions at least partially of conical or frustoconical shape, the fibrous structures comprising fibers extending in at least one determined direction, wherein the fibrous structures are deposited on the draping shape so that fibers of said fibrous structures overlap at straight lines of a developed surface of the developable portion of the draping shape, the fibrous structures being draped so as to form one or more developable fibrous layers on the developable portion of the draping shape, the fibrous layer(s) extending around the developable portion of the draping shape between a first and a second edge, the fibrous structures of the same fibrous layer being deposited so that the fibers of the fibrous structures of said fibrous layers are overlapping at least at one set of parallel straight lines of the developed surface of said fibrous layer.

2. The draping method according to claim 1, wherein a set of fibrous layers is draped over the draping shape such that in each fibrous layer of the set of fibrous layers the fibers extend in at least one direction of extension which forms a non-zero crossing angle with the direction(s) of extension of the fibers of the other layers of the set of fibrous layers.

3. The draping method according to claim 2, wherein the crossing angle is comprised between 80% and 120% of a multiple of a ratio of 180° by a total number of layers in the set of fibrous layers.

4. The draping method according to claim 2, wherein the crossing angle is comprised between 80% and 120% of a multiple of a ratio of 180° by a total number of layers in the set of fibrous layers at least at one generatrix of the draping shape.

5. The draping method according to claim 2, wherein the crossing angle is comprised between 80% and 120% of a multiple of a ratio of 180° by a total number of layers in the set of fibrous layers at any point of the draping.

6. The draping method according to claim 2, wherein first edges of the fibrous layers of the set of fibrous layers are circumferentially offset relative to each other on the draping shape and wherein second edges of the fibrous layers of the set of fibrous layers are circumferentially offset relative to each other on the draping shape.

7. The draping method according to claim 1, wherein at least a first portion of a second edge of at least one fibrous layer joins a first edge of said fibrous layer, said first portion of the second edge extending from a largest end contour of said fibrous layer connecting the first edge to the second edge.

8. The draping method according to claim 7, wherein the first and second edges of at least one fibrous layer meet and correspond to a generatrix of said fibrous layer.

9. The draping method according to claim 7, wherein the first edge of at least one fibrous layer extends in the same direction as the fibers of the fibrous structures of said layer present on a side of the first edge.

10. The draping method according to claim 7, wherein the second edge comprises a second portion distinct from the first portion extending in the same direction as the fibers of the fibrous structures of said layer present on the side of the second edge.

11. The draping method according to claim 7, wherein the first edge covers at least the first portion of the second edge.

12. The draping method according to claim 1, the method further comprising draping a plurality of stiffening fibrous structures over the draping shape, the stiffening fibrous structures being draped such that the fibers of said stiffening fibrous structures overlap at generatrices of the developed surface of the draping shape.

13. The draping method according to claim 1, wherein the draping of the fibrous structures is carried out by automatic placement of fibers.

14. A fibrous preform comprising at least one developable portion, the developable portion comprising at least one portion of conical or frustoconical shape or comprising portions at least partially of conical or frustoconical shape, said preform comprising a plurality of fibrous layers formed by fibrous structures, wherein fibers of the fibrous structures of at least one fibrous layer correspond to straight lines of a developed surface of the developable portion of the fibrous preform, said at least one fibrous layer being developable and said fibers of said at least one fibrous layer overlapping at least at one set of parallel straight lines of the developed surface of said fibrous layer.
